(19) United States
(12) Patent Application Publication
(10) Pub. No.: US 2007/0149692 A1
(43) Pub. Date: Jun. 28, 2007

(54) Tape, tape backing film and fabrication method thereof

(75) Inventors: Lucky Lee, Hsinchu City (TW); Tai Hsun Lee, Taoyuan County (TW); Ching Chih Lai, Hsinchu (TW); Yan-Sheng Yang, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/387,837

(22) Filed: Mar. 24, 2006

(30) Foreign Application Priority Data
Dec. 28, 2005 (TW) 94146953

(51) Int. Cl. C08K 5/00

(52) U.S. Cl. 524/515; 525/240; 264/211.23; 264/210.2

(57) ABSTRACT

A tape backing film is provided, comprising 20 to 80 parts by weight of polyolefin and 20 to 80 parts by weight of EPDM rubber or EPR rubber. The polyolefin comprises 50 to 90% by weight of polyethylene and 50 to 10% by weight of polypropylene.

### BACKGROUND OF THE INVENTION

1. Field of the Invention

The invention relates to tape backing film, and in particular to heat-resistant tape backing film and fabrication method thereof.

2. Description of the Related Art

Tape backing film is commonly made with polyvinyl chloride (PVC) due to its low cost, good processability, heat resistance, and flame retardant properties. In the last decade, however, environmentally friendly materials, or eco-materials, have been extensively developed.

Environmental pollution is produced by PVC tape backing film such as dioxins produced during fabrication or disposal.

U.S. Pat. No. 5,284,889 discloses an electrical insulating film comprising 60 to 100 parts of an ethylene vinyl acetate copolymer (EVA), 0 to 40 parts of ethylene propylene diene rubber (EPDM rubber), 0.05 to 5 parts of a silane coupling agent, 5 to 25 parts of a bromine containing flame retardant, 1.5 to 10 parts of an antimony containing flame retardant, and 1 to 20 parts of metal oxide hydrates, although, being reinforced by crosslinking, it is difficult to recycle and reuse.

U.S. Pat. No. 5,498,476 discloses an electrical insulating film comprising 60 to 100 parts of EVA, 0 to 40 parts of EPDM rubber, 0.05 to 5 parts of an amino-functional silane coupling agent, and 40 to 150 parts of ethylene diamine phosphate flame retardant, is also difficult to recycle and reuse.

U.S. Pat. No. 6,376,068 discloses an insulation protection film comprising polyolefin, EPDM rubber, flame retardants, and further comprising plasticizers, dyes, pigments, antioxidants, or antistatic agents for use in the protection of steel pipes.

Tape backing film materials as described above have been developed to replace PVC, but constituent crosslinking agents for reinforcement, emulating the physical characteristics of a PVC tape, make them disadvantageous to recycling and reuse.

Thus, an improved heat-resistant tape backing film and fabrication method thereof is called for.

### BRIEF SUMMARY OF THE INVENTION

A detailed description is given in the following embodiments with reference to the accompanying drawings.

In an embodiment of the invention, a tape backing film is provided, comprising 20 to 80 parts by weight of polyolefin and 20 to 80 parts by weight of EPDM rubber or EPR rubber. The polyolefin comprises 50 to 90% by weight of polyethylene and 50 to 10% by weight of polypropylene.

In another embodiment, a tape is provided, comprising the disclosed tape backing film and an adhesive coated on a surface thereof.

A method for tape backing film fabrication is also provided. A mixture of polyolefin and a rubber is provided. The polyolefin comprises polyethylene and polypropylene, and the rubber comprises EPDM rubber or EPR rubber. A first film is formed from the mixture by melting at 150 to 350⁰C. A second film is formed by drawing the first film at a stretch ratio of from 1:1 to 1:10 in two perpendicular directions. A surface treatment is performed on the second film.

### BRIEF DESCRIPTION OF THE DRAWINGS

The invention can be more fully understood by reading the subsequent detailed description and examples with references made to the accompanying drawings, wherein:

FIG. 1 is a flowchart of a tape backing film fabrication according to the invention.

FIG. 2 is a cross-section of a tape of an embodiment of the invention.

FIG. 3 shows a stress-strain comparison between of an embodiment and another film.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A tape backing film according to the invention is halogen-free, recyclable, PVC-like, and heat-resistant, obtained by processing a mixture containing polyethylene (PE), polypropylene (PP), and EPDM rubber using a unique method.

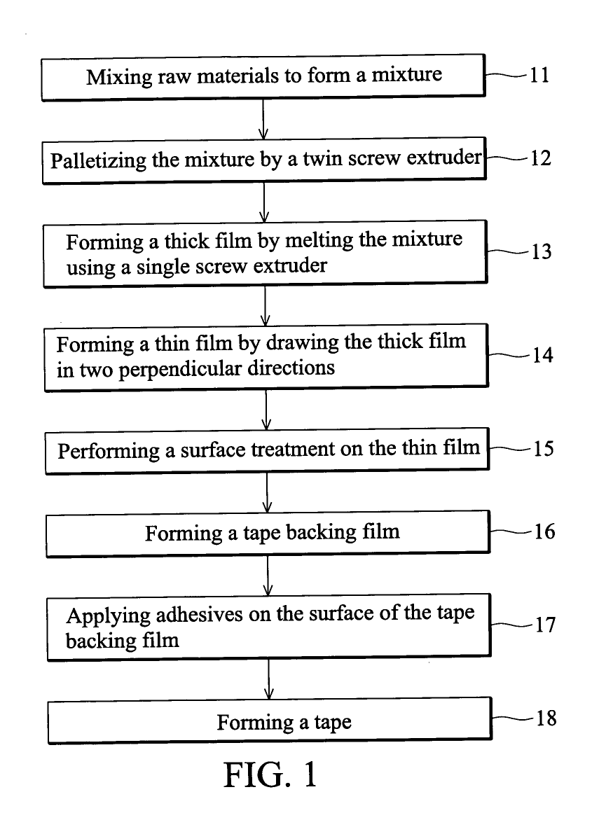

FIG. 1 is a flowchart of a tape backing film fabrication according to the invention, comprising mixing materials in step 11, palletizing the mixture by a twin screw extruder in step 12, forming a thick film by melting the mixture using a single screw extruder at 150 to 350⁰C in step 13, forming a thin film by drawing the thick film in two perpendicular directions in step 14, performing a surface treatment on the thin film in step 15 to form a tape backing film with enhanced surface adhesion in step 16, and applying adhesives on the surface of the tape backing film in step 17 to form a tape in step 18.

Referring to FIG. 1, PE, PP and EPDM rubber are mixed by a mixer or extruder in step 11. Other additives, such as fillers, colorant, flame retardant or processing aids, can also be added into the mixture.

After mixing, the mixture may be pelletized by a twin screw extruder at about 100 to 240° C. in step 12. In another embodiment, however, palletizing the mixture is not required since the mixture is directly transported to a single screw extruder for melting.

A thick film is formed by melting the mixture or pellets at 150 to 350° C., preferably 170 to 320° C., in step 13. The thick film is formed by blown film molding, single screw extrusion molding, twin screw extrusion molding, or calendering. In a preferred embodiment, the thick film is formed by a single screw extruder at 170 to 320° C.

The thick film is drawn at a stretch ratio of from 1:1 to 1:10, preferably 1:1 to 1:5, in a longitudinal direction, and at a stretch ratio from 1:1 to 1:10, preferably 1:1 to 1:5, in a transverse direction to form a thin film in step 14. After stretching, the thin film has physical properties similar to PVC backing films. In a preferred embodiment, the thick film is drawn at a stretch ratio of 1:3 in a longitudinal direction, and at a stretch ratio of 1:4 in a transverse direction.

The thin film is subjected to a surface treatment to improve adhesion between the thin film and subsequently formed adhesives in step 15, and a tape backing film is formed in step 16. The surface treatment can be corona treatment (for example, 2000 to 20000 volt/cm²), chemical treatment (for example, coating a primer), or the like. The tape backing film has a thickness of about 0.02 to 0.30 mm, preferably 0.08 to 0.20 mm. The backing film is uniformly coated with a layer of polymeric pressure sensitive adhesive, such as acrylic adhesive or rubber adhesive, with a thickness of 0.01 to 0.05 mm and having an adhesive force of 1.4 to 5.8 kgf/19 mm.

After coating, a tape is formed in step 18. The tape backing film of the tape is halogen-free, recyclable, and heat-resistant, such that conventional PVC tape backing film can be replaced.

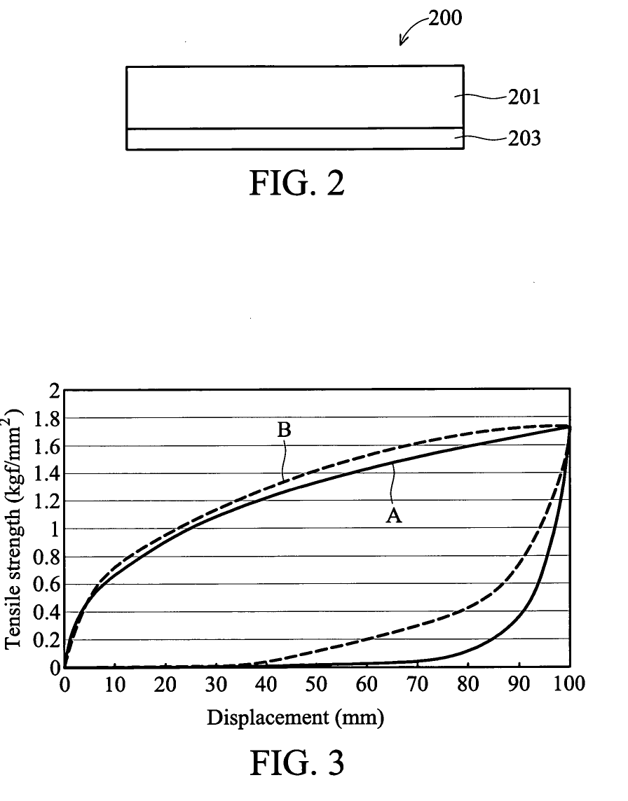

FIG. 2 is a cross section of a tape according to the invention, comprising a tape backing film 201 and adhesive 203. The tape backing film 201 comprises PE, PP, and EPDM rubber. In other embodiments, other additives, such as fillers, colorant, flame retardant or processing aids can be contained in the tape backing film 201. In yet another embodiment, EPDM rubber can be replaced with ethylene propylene rubber (EPR rubber).

The tape backing film 201 comprises 20 to 80 parts by weight of polyolefin, preferably 30 to 70, and more preferably 40 to 60. In an embodiment, polyolefin, comprising PE and PP, comprises 50 to 90% by weight of PE and 50 to 10% by weight of PP, or, in another embodiment, 60 to 80% by weight of PE and 40 to 20% by weight of PP. The tape backing film 201 also comprises 20 to 80 parts by weight of EPDM rubber or EPR rubber, preferably 30 to 70, and more preferably 40 to 60.

In embodiments, the tape backing film 201 may contain other additives, such as 0.01 to 20% by weight of flame retardant, 0.01 to 15% by weight of colorant, 0.01 to 30% by weight of filler, or 0.01 to 20% by weight of processing aid.

The molecular weight of PE ranges from about 50,000 to 300,000, and preferably from about 100,000 to 200,000. The molecular weight of PP ranges from about 300,000 to 700,000, and preferably from about 300,000 to 500,000. The EPDM rubber may contain about 50 to 95 parts by weight of ethylene, about 5 to 50 parts by weight of propylene, and about 0.01 to 3 parts by weight of diene. The EPR rubber may contain about 50 to 95 parts by weight of ethylene, and about 5 to 50 parts by weight of propylene.

The tape backing film 201 may contain flame retardants, such as phosphorous compounds, inorganic salts, or halogenated compounds.

The tape backing film 201 may contain colorants, such as pigment or dye.

The tape backing film 201 may contain fillers, such as silicon dioxide, titanium dioxide, calcium carbonate, magnesium carbonate, calcium sulfate, barium sulfate, or aluminum silicate, as long as the fillers do not affect the desired physical properties of tape backing films.

The tape backing film 201 may contain processing aids, such as release agents, coupling agents, or lubricants. The type and amount of the processing aids depend on the manufacturing process of tape backing films, and may or may not be added to the tape backing film 201 as long as the processing aids do not affect the desired physical properties of the backing film.

The tape backing film 201 may contain UV stabilizers, plasticizers, fungicides, waxes, or antioxidants.

Thickness of tape backing films according to the invention is about 0.02 to 0.30 mm, and preferably about 0.08 to 0.20 mm. The tensile strength is between 1.3 and 3.0 kgf/mm². The elongation at break is between 100% and 700%. The breakdown voltage is between 39 and 150 kv/mm. The deformation set is between 5% and 20%.

### Embodiment

70 parts by weight of PE (C7100, produced by Asia Polymer corporation, Taiwan), 30 parts by weight of PP (H1022, BASELL corporation), 70 parts by weight of EPDM rubber (Nordel 3725, DuPont), 4.0 parts by weight of a release agent, and 8.0 parts by weight of flame retardant were placed in a mixer and pelletized by a twin screw extruder at 190° C. The resulting pellets were placed in a single screw extruder with a screw of 90 mm in diameter, ratio of screw length to screw diameter (L/D) of 30, and a die of 400 mm in diameter at 170 to 320° C. to undergo extrusion and blow molding to form a thick film. The thickness of the thick film at the die orifice opening was 1.8 mm. The thick film was drawn at a stretch ratio of 1:3 in a longitudinal direction and at a stretch ratio of 1:4 in a transverse direction, and a thin film of 0.15 mm thickness formed. The thin film was subjected to corona treatment at 5000 voltage/cm², and a tape backing film formed.

Comparison 1

100 parts by weight of PE (C7100, produced by Asia Polymer corporation, Taiwan), 118 parts by weight of EPDM rubber (Nordel 1070, DuPont), and 4.4 parts by weight of a release agent were placed in a mixer and pelletized by a twin screw extruder at 190° C. The resulting pellets were placed in a single screw extruder with a screw of 90 mm in diameter, ratio of screw length to screw diameter (L/D) of 30, and a die of 400 mm in diameter at 140 to 180° C. to undergo extrusion and blow molding to form a thick film. The thickness of the thick film at the die orifice opening was 1.8 mm. The thick film was drawn at a stretch ratio of 1:3 in a longitudinal direction and at a stretch ratio of 1:4 in a transverse direction, and a thin film of 0.15 mm thickness formed. The thin film was subjected to corona treatment at 2000 voltage/cm², and a tape backing film formed.

Comparison 2

PVC tape backing film with a thickness of 0.15 mm. (type 211, ACHEM Technology Corporation, Taiwan)

Test 1

Tensile strength, elongation at break, breakdown voltage, deformation set and heat resistance of the embodiment and comparisons were respectively tested according to the UL-510 test standard. Results are shown in Table 1.

TABLE 1

| | Tensile | | Breakdown | | |
|---|---|---|---|---|---|
| Test items | strength | Elongation | voltage | Deformation | Heat resistance |
| units | kgf/mm² | at break % | kV/mm | set % | 87° C.*1440 hr |
| UL-510 | 1.05 | 100 | 39 | — | No cracks and |
| qualified | | | | | corrosion are |
| standard | | | | | appeared |
| Embodiment | 2.6 | 620 | 80.1 | 13˜15 | Qualified |
| Comparison 1 | 1.3 | 620 | 78.7 | 11˜13 | Unqualified |
| Comparison 2 | 2.5 | 124 | 79 | 9˜12 | Qualified |

As shown in Table 1, the disclosed backing film shows similar physical properties to the PVC tape backing films (comparison 2), has higher tensile strength than comparison 1, and has qualified heat resistance according to UL-510 test standards.

Test 2

The stress-strain properties of the embodiment and comparison 2 were respectively tested according to CNS C4049 test standard with a stretching speed of 200 mm/min as shown in FIG. 3. Curves A and B indicate the experimental results of the comparison 2 and the embodiment, respectively. As shown, when the tape backing films of the embodiment are stretched or contracted, tensile strength demonstrated was similar to that of conventional PVC tape backing films. That is, the disclosed backing film exhibits qualities similar to conventional PVC tape backing films, such as resilience, tenacity, texture, and tight contraction and envelopment after stretching.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A tape backing film, comprising:
20 to 80 parts by weight of polyolefin; and
20 to 80 parts by weight of EPDM rubber or EPR rubber;
wherein the polyolefin comprises 50 to 90% by weight of polyethylene and 50 to 10% by weight of polypropylene.

2. The tape backing film of claim 1, wherein the tape backing film comprises 30 to 70 parts by weight of polyolefin.

3. The tape backing film of claim 1, wherein the tape backing film comprises 40 to 60 parts by weight of polyolefin.

4. The tape backing film of claim 1, wherein the tape backing film comprises 30 to 70 parts by weight of EPDM rubber or EPR rubber.

5. The tape backing film of claim 1, wherein the tape backing film comprises 40 to 60 parts by weight of EPDM rubber or EPR rubber.

6. The tape backing film of claim 1, further comprising 0.01 to 20% by weight of flame retardant.

7. The tape backing film of claim 1, further comprising 0.01 to 15% by weight of colorant.

8. The tape backing film of claim 1, further comprising 0.01 to 30% by weight of filler.

9. The tape backing film of claim 1, further comprising 0.01 to 20% by weight of processing aid.

10. The tape backing film of claim 1, wherein the tape backing film has a tensile strength of 1.3 to 3.0 kgf/mm².

11. The tape backing film of claim 1, wherein the tape backing film has an elongation at break of 100% to 700%.

12. The tape backing film of claim 1, wherein the tape backing film has a breakdown voltage of 39 to 150 kv/mm.

13. The tape backing film of claim 1, wherein the tape backing film has a recovery from deformation of 5 to 20%.

14. The tape backing film of claim 1, wherein the tape backing film has a thickness of 0.02 to 0.30 mm.

15. A method of fabricating a tape backing film, comprising:
providing a mixture of polyolefin and a rubber, wherein the polyolefin comprises polyethylene and polypropylene, and the rubber comprises EPDM rubber or EPR rubber;
forming a first film from the mixture by melting the mixture at 150 to 350⁰C;
forming a second film by drawing the first film at a stretch ratio of from 1:1 to 1:10 in two perpendicular directions; and
performing a surface treatment on the second film.

16. The method of claim 15, wherein the first film is formed by melting the mixture at 170 to 320⁰C.

17. The method of claim 15, wherein the second film is formed by drawing the first film at a stretch ratio of from 1:1 to 1:5 in two perpendicular directions.

18. The method of claim 15, wherein the mixture comprises:
20 to 80 parts by weight of polyolefin; and
20 to 80 parts by weight of EPDM rubber or EPR rubber;
wherein the polyolefin comprises 50 to 90% by weight of polyethylene and 50 to 10% by weight of polypropylene.

19. The method of claim 15, wherein the surface treatment is corona treatment or chemical treatment.

20. The method of claim 15, wherein the first film is formed from the mixture by blow molding, single screw extrusion molding, twin screw extrusion molding, or calendering.

21. The method of claim 20, wherein the first film is formed by single screw extrusion molding with a ratio of a screw length to a screw diameter equaling 30.

22. The method of claim 15, wherein the mixture is a pellet.

23. The method of claim 22, wherein the pellet is formed by twin screw extrusion molding.

24. A tape, comprising:
a tape backing film of claim 1; and
an adhesive coated on a surface of the tape backing film.
